(19) United States
(12) Patent Application Publication
(10) Pub. No.: US 2011/0112005 A1
(43) Pub. Date: May 12, 2011

(54) Laundry Detergent Composition

(76) Inventors: Alan Thomas Brooker, Newcastle (GB); James Charles Theophile Roger Burckett-St. Laurent, Lasne (BE)

(21) Appl. No.: 12/944,830

(22) Filed: Nov. 12, 2010

(30) Foreign Application Priority Data
Nov. 12, 2009 (EP) 09175859.9
Nov. 12, 2009 (EP) 09175864.9

(51) Int. Cl. C11D 17/00; C11D 1/29; C11D 17/08; C11D 3/37; C11D 1/37; C11D 3/386

(52) U.S. Cl. 510/321; 510/357; 510/337; 510/343; 510/355; 510/358; 510/320

(57) ABSTRACT

A laundry detergent composition having: (a) from about 1 wt % to about 20 wt % by weight of an alkyl ether sulfate of the general formula: R—(OCH₂CH₂)ₓ—O—SO₃M, wherein R is a non-petroleum derived fatty alcohol with even number of carbon chain lengths of from about C₈ to about C₂₀ and wherein x is from about 0.5 to about 8, and where M is an alkali metal or ammonium cation; wherein the composition is substantially free of zeolite builder; wherein the composition is substantially free of phosphate builder; and wherein the composition is substantially free of silicate salt.

### FIELD OF THE INVENTION

The present invention relates to a solid or liquid detergent compositions comprising only biodegradable and eco-friendly ingredients that exhibit exceptional performance compared to traditional detergent formulations that use less friendly surfactant and builder ingredients. In particular, this invention relates to ecologically responsible laundry detergent compositions that utilize unique surfactant-builder-enzyme combinations in conjunction with performance boosting natural essences.

### BACKGROUND OF THE INVENTION

Laundry detergents have been known in the art for decades. Modern detergents are often comprised of blends of synthetic anionic, nonionic and cationic surfactants, along with any number of additional ingredients such as builders, water-conditioners, dispersants, soil-release polymers, detersive enzymes and bleaching agents to improve cleaning performance and to achieve performance/cost optimized compositions that are consumer acceptable. Although major strides over decades have moved laundry detergents away from environmentally adverse ingredients such as phosphates, much of the detergents today unfortunately continue to use synthetic surfactants that although biodegradable are petroleum derived. There is a continued need to improve the environmental profile of these laundry detergents. Many of the surfactants used today are of petroleum base rather than vegetable or animal sourced. Additionally, there is a need to improve the environmental profile of some solvents, synthetic polymers, chelants, and bleaching agents. The art is nearly void of compositions that claim the use of eco-friendly ingredients yet still have suitable performance. Heretofore there have simply been no suitable “across-the-board” substitutions of environmentally challenging ingredients with eco-friendly ingredients in a laundry detergent composition that can provide consumer acceptable performance at reasonable cost to the manufacturer. It is simple (as shown in the art) to make small substitutions, for example, reduction of builder and/or surfactant levels by increasing enzyme levels, or elimination of phosphates by substitution with other carbonate or bicarbonate builders and biodegradable chelants, but no where is there described the complete replacement of all ingredients in a composition with eco-friendly ingredients to produce an environmentally responsible composition that still provides comparable performance.

One way to increase performance in a laundry detergent and concomitantly improve its environmental profile is to replace high surfactant and builder levels with high enzyme levels. This strategy is well known in the art, for example US Patent Application Publication US2006/0205628 to Novozymes describes in general terms the “replacement of surfactants, builders, polymers, and bleaches in detergent compositions with enzymes”. However, it is problematic to apply this strategy for the replacement of all environmentally challenging ingredients within a composition, as the required multiple types of enzymes need to be combined and stabilized in ways that heretofore have not been explored, and additional ingredients beyond the enzymes will be needed to make up for lost performance, (e.g. abnormally high levels of optical brightener, or synthetic polymers). For example, when common surfactants are replaced with eco-friendly surfactants, and the highly alkaline builder/chelant systems are eliminated, then simply increasing enzyme level is not enough, and the technology that is truly missing from the art is how to combine the right combinations of different enzymes at the right levels, using the right enzyme stabilizers with the right eco-friendly co-ingredients to boost the performance back to consumer acceptable levels.

One attempt to achieve a multiple-enzyme/surfactant based laundry detergent system is described in U.S. Pat. No. 6,060,441 to Hessel, et al.

Incorporating essential oils into detergent compositions is barely known in the laundry detergent context. However, solvent cleaners containing essential oils are well known in institutional and household hard surface cleaning. For example, the popular OrangeGlo® cleaners, marketed by Church & Dwight Co., Inc., are stable micro-emulsions of natural oils such as orange oil in water with surfactants and other ingredients. Patent examples include U.S. Pat. No. 6,407,051 to Smith, et al. that describes emulsifying oils or hydrocarbons such as mineral oil, mineral spirits, pine oil, fatty esters, carboxylic diester oils, motor oils, or triglycerides, and the like into stable water-in-oil micro-emulsions through a combination of alcohol ethoxylate and alkyl polyglycoside surfactant mixtures.

U.S. Pat. No. 6,136,778 to Kamiya describes the incorporation of essential oils into dishwashing detergents.

Additionally, U.S. Pat. No. 6,333,301 also to Kamiya claims a particulate detergent incorporating as much as 10% by weight of terpenes.

Finally, U.S. Pat. No. 7,033,984 to Hafkamp, et al., and U.S. Pat. No. 7,030,077 to Beers, et al., claim herbal benefit in the laundry through the incorporation of herbal extracts in laundry detergents that deposit the benefit agent onto the clothing that then transfers the benefit agent to the person wearing that clothing.

### SUMMARY OF THE INVENTION

The present invention provides a solid or liquid laundry detergent composition comprising: (a) from about 1 wt % to about 20 wt % by weight of an alkyl ether sulfate of the general formula:

R—(OCH₂CH₂)ₓ—O—SO₃M

wherein R is a non-petroleum derived fatty alcohol with even number of carbon chain lengths of from about C₈ to about C₂₀ and wherein x is from about 0.5 to about 8, and where M is an alkali metal or ammonium cation;

(b) optionally, from about 1 wt % to about 10 wt % by weight of a fatty alcohol ethoxylate of general formula:

R—(OCH2CH2-OH

wherein R is a non-petroleum derived fatty alcohol with even number carbon chain lengths of from about C₁₀ to about C₁₈, and wherein x is from about 0.5 to about 9; and

(c) optionally from about 0.1% to about 5% of a natural essence.

### DETAILED DESCRIPTION OF THE INVENTION

The present invention relates to a solid or liquid composition for laundering fabrics that exhibits good performance such as stain removal and whiteness retention. In a preferred embodiment, the compositions are comprised entirely of ecologically responsible ingredients. The laundry detergent compositions of the present invention may include anionic surfactant components, preferably alkyl ether sulfates, alkyl sulfate, alpha-sulfonated fatty acid esters, and/or fatty acid soaps, which together total from about 1 wt % to about 20 wt %; optionally nonionic surfactants, most preferably the non-petroleum derived fatty alcohol ethoxylates and/or alkyl polyglycoside surfactants, totaling from about 1 wt % to about 10 wt %; optionally, a “natural essence” such as an essential oil, natural tree, plant, fruit, nut or seed extract, or other purified synthetic organic material to boost performance and enzyme stability, and in many instances to also provide fragrance, totally from about 0.1 wt % to about 5 wt %; optionally, a builder, most preferably carbonate, bicarbonate, and/or citrate, present from about 0.1 wt % to about 10 wt %; optionally a soil dispersant/anti-redeposition or soil releasing polymer from about 0.1 wt % to about 5 wt %; and, optionally one or more detersive enzymes at from about 0.0001 wt % to about 5 wt %. It is highly preferred for the composition to be essentially free from Boron. Preferably, no deliberately added boron is incorporated into the composition.

Anionic Surfactant Component

The eco-friendly detergent compositions of the present invention preferably include at least one anionic surfactant. Preferred anionic surfactants for use in the present invention include the alkyl ether sulfates, also known as alcohol ether sulfates. Alcohol ether sulfates are the sulfuric monoesters of the straight chain or branched alcohol ethoxylates and have the general formula R—(OCH2CH2)x-O—SO3M, where R preferably comprises C7-C21 alcohol ethoxylated with from about 0.5 to about 9 mol of ethylene oxide (i.e., x=0.5 to 9 EO), such as C12-C18 alcohols containing from 0.5 to 9 EO, and where M is alkali metal or ammonium, alkyl ammonium or alkanol ammonium counterion. Preferred alkyl ether sulfates for use in one embodiment of the present invention are C8-C18 alcohol ether sulfates with a degree of ethoxylation of from about 0.5 to about 9 ethylene oxide moieties and most preferred are the C12-C15 alcohol ether sulfates with ethoxylation from about 4 to about 9 ethylene oxide moieties, with 7 ethylene oxide moieties being most preferred. In another embodiment, the C12-C15 alcohol ether sulfates with ethoxylation from about 0.5 to about 3 ethylene oxide moieties are preferred. In keeping with the spirit of only using natural feedstock for ingredients for an eco-friendly detergent of the present invention, the fatty alcohol portion of the surfactant is preferably animal or vegetable derived, rather than petroleum derived. Therefore the fatty alcohol portion of the surfactant will comprise distributions of even number carbon chains, e.g. C12, C14, C16, C18, and so forth. It is understood that when referring to alkyl ether sulfates, these substances are already salts (hence “sulfate” nomenclature), and most preferred and most readily available are the sodium alkyl ether sulfates (also referred to as NaAES, or simply FAES). Commercially available alkyl ether sulfates include the CALFOAM® alcohol ether sulfates from Pilot Chemical, the EMAL®, LEVENOL® and LATEMAL® products from Kao Corporation, and the POLYSTEP® products from Stepan, most of these with fairly low EO content (e.g., average 3 or 4-EO). Alternatively the alkyl ether sulfates for use in the present invention may be prepared by sulfonation of alcohol ethoxylates (i.e., nonionic surfactants) if the commercial alkyl ether sulfate with the desired chain lengths and EO content are not easily found, but perhaps where the nonionic alcohol ethoxylate starting material may be. For example, sodium lauryl ether sulfate (“sodium laureth sulfate”, having about 2-3 ethylene oxide moieties) is very readily available commercially and quite common in shampoos and detergents. Sodium lauryl ether sulfate is preferred for use in the detergents of the present invention. Depending on the degree of ethoxylation desired, it may be more practical to sulfonate a commercially available nonionic surfactant such as Neodol® 25-7 Primary Alcohol Ethoxylate (a C12-C15/7EO nonionic from Shell) to obtain for example the C12-C15/7EO alkyl ether sulfate that may have been more difficult to source commercially. However, the most preferred alkyl ether sulfate for use in the present invention is sodium lauryl sulfate-2EO, available as Calfoam® ES-302 from Pilot Chemical. The preferred level of C12-C18/0.5-9EO alkyl ether sulfate for use in the present invention is from about 1 wt % to about 50 wt %. More preferred is to incorporate sodium lauryl ether sulfate (e.g. Calfoam® ES-302) from about 3 wt % to about 15 wt % actives weight basis.

Other optionally anionic surfactants that may find use in the compositions of the present invention include the alpha-sulfonated alkyl esters of C12-C16 fatty acids. The alpha-sulfonated alkyl esters may be pure alkyl ester or a blend of (1) a mono-salt of an alpha-sulfonated alkyl ester of a fatty acid having from 8-20 carbon atoms where the alkyl portion forming the ester is straight or branched chain alkyl of 1-6 carbon atoms and (2) a di-salt of an alpha-sulfonated fatty acid, the ratio of mono-salt to di-salt being at least about 2:1. The alpha-sulfonated alkyl esters useful herein are typically prepared by sulfonating an alkyl ester of a fatty acid with a sulfonating agent such as SO3. When prepared in this manner, the alpha-sulfonated alkyl esters normally contain a minor amount, (typically less than 33% by weight), of the di-salt of the alpha-sulfonated fatty acid which results from saponification of the ester. Preferred alpha-sulfonated alkyl esters contain less than about 10% by weight of the di-salt of the corresponding alpha-sulfonated fatty acid.

The alpha-sulfonated alkyl esters, i.e., alkyl ester sulfonate surfactants, include linear esters of C8-C20 carboxylic acids that are sulfonated with gaseous SO3 as described in the “The Journal of American Oil Chemists Society,” 52 (1975), pp. 323-329. Suitable starting materials preferably include natural fatty substances as derived from tallow, palm oil, etc., rather than petroleum derived materials. The preferred alkyl ester sulfonate surfactants, especially for laundry detergent compositions of the present invention, comprise alkyl ester sulfonate surfactants of the structural formula R3-CH(SO3M)-CO2R4, wherein R3 is a C8-C20 hydrocarbon chain preferably naturally derived, R4 is a straight or branched chain C1-C6 alkyl group and M is a cation which forms a water soluble salt with the alkyl ester sulfonate, including sodium, potassium, magnesium, and ammonium cations. Preferably, R3 is C10-C16 fatty alkyl, and R4 is methyl or ethyl. Most preferred are alpha-sulfonated methyl or ethyl esters of a distribution of fatty acids having an average of from 12 to 16 carbon atoms. For example, the alpha-sulfonated esters; Alpha-Step® BBS-45, Alpha-Step® MC-48, and Alpha-Step® PC-48, all available from the Stepan Co. of Northfield, Ill., may find use in the present invention. However, the methyl esters are derived from methanol sources. Thus, the ethyl esters, which are currently not commercially available, would be the most preferred alpha-sulfonated fatty acid esters. When used in the present invention, the alpha-sulfonated alkyl ester is preferably incorporated at from about 3% to about 15% by weight actives.

The compositions of the present invention may also include fatty acid soaps as an anionic surfactant ingredient. The fatty acids that may find use in the present invention may be represented by the general formula R—COOH, wherein R represents a linear or branched alkyl or alkenyl group having between about 8 and 24 carbons. It is understood that within the compositions of the present invention, the free fatty acid form (the carboxylic acid) will be converted to the carboxylate salt in-situ (that is, to the fatty acid soap), by the excess alkalinity present in the composition from added alkaline builder. As used herein, “soap” means salts of fatty acids. Thus, after mixing and obtaining the compositions of the present invention, the fatty acids will be present in the composition as R—COOM, wherein R represents a linear or branched alkyl or alkenyl group having between about 8 and 24 carbons and M represents an alkali metal such as sodium or potassium. The fatty acid soap, which is often a desirable component having suds reducing effect in the washer, (and especially advantageous for side loading or horizontal tub laundry machines), is preferably comprised of higher fatty acid soaps. The fatty acids that are added directly into the compositions of the present invention may be derived from natural fats and oils, such as those from animal fats and greases and/or from vegetable and seed oils, for example, tallow, hydrogenated tallow, whale oil, fish oil, grease, lard, coconut oil, palm oil, palm kernel oil, olive oil, peanut oil, corn oil, sesame oil, rice bran oil, cottonseed oil, babassu oil, soybean oil, castor oil, and mixtures thereof. Although fatty acids can be synthetically prepared, for example, by the oxidation of petroleum, or by hydrogenation of carbon monoxide by the Fischer-Tropsch process, the naturally obtainable fats and oils are preferred. The fatty acids of particular use in the present invention are linear or branched and containing from about 8 to about 24 carbon atoms, preferably from about 10 to about 20 carbon atoms and most preferably from about 14 to about 18 carbon atoms. Preferred fatty acids for use in the present invention include coconut, tallow or hydrogenated tallow fatty acids, and most preferred is to use entirely coconut fatty acid. Preferred salts of the fatty acids are alkali metal salts, such as sodium and potassium or mixtures thereof and, as mentioned above, preferably the soaps generated in-situ by neutralization of the fatty acids with excess alkali from the silicate. Other useful soaps are ammonium and alkanol ammonium salts of fatty acids, with the understanding that these soaps would necessarily be added to the compositions as the preformed ammonium or alkanol ammonium salts and not neutralized in-situ within the added alkaline builders of the present invention. The fatty acids that may be included in the present compositions will preferably be chosen to have desirable detergency and suds reducing effect. Fatty acid soaps may be incorporated in the compositions of the present invention at from about 1% to about 10%.

The compositions of the present invention may also include alkyl sulfate as the sole anionic surfactant component, or in combination with one of more other anionic surfactants mentioned above. Fatty alkyl sulfates have the general formula R—SO3M, where R preferably comprises a C7-C21 fatty alkyl chain, and where M is alkali metal or ammonium, alkyl ammonium or alkanol ammonium counterion. Preferred alkyl sulfates for use in the present invention are C8-C18 fatty alkyl sulfate. Most preferred is to incorporate sodium lauryl sulfate, such as Standapol® WAQ-LC marketed by Cognis, and to have from about 1% to about 10% by actives weight basis in the composition.

The Nonionic Surfactant Component

The compositions of the present invention may also include at least one nonionic surfactant since these materials are particularly good at removing oily soils from fabrics and may be naturally derived and have good biodegradability. For example, the compositions herein may contain ethoxylated primary alcohols represented by the general formula R—(OCH2CH2)x-OH, where R is C10 to C18 carbon atoms preferably from natural, non-petroleum sources, and x is on average from 4 to 12 mol of ethylene oxide (EO). Further examples are alcohol ethoxylates containing linear radicals from alcohols of natural origin having 12 to 18 carbon atoms, e.g., from coconut, palm, tallow fatty or oleyl alcohol and on average from 4 to about 12 EO per mole of alcohol. Most useful as a nonionic surfactant in the present invention is the C12-C14 alcohol ethoxylate-7EO, and the C12-C14 alcohol ethoxylate-12EO incorporated in the composition at from about 1 wt % to about 10 wt %. Preferred nonionic surfactants for use in this invention include for example, Neodol® 45-7, Neodol® 25-9, or Neodol® 25-12 from Shell Chemical Company and most preferred are Surfonic® L24-7, which is a C 12-C 14 alcohol ethoxylate-7EO, and Surfonic® L24-12, which is a C12-C14 alcohol ethoxylate-12EO, both available from Huntsman. Combinations of more than one alcohol ethoxylate surfactant may also be desired in the detergent composition in order to maximize cleaning performance in the washing machine.

Nonionic surfactants useful in the present invention may also include the alkyl polyglycoside surfactants. The alkyl polyglycosides (APGs), also called alkyl polyglucosides if the saccharide moiety is glucose, are naturally derived, nonionic surfactants. The alkyl polyglycosides that may be used in the present invention are fatty ester derivatives of saccharides or polysaccharides that are formed when a carbohydrate is reacted under acidic condition with a fatty alcohol through condensation polymerization. The APGs are typically derived from corn-based carbohydrates and fatty alcohols from natural oils in animals, coconuts and palm kernels. Such methods for preparing APGs are well known in the art. For example, U.S. Pat. No. 5,003,057 to McCurry, et al., incorporated herein, describes methods for making APGs, along with their chemical properties. The alkyl polyglycosides that are preferred for use in the present invention contain a hydrophilic group derived from carbohydrates and is composed of one or more anhydroglucose units. Each of the glucose units can have two ether oxygen atoms and three hydroxyl groups, along with a terminal hydroxyl group, which together impart water solubility to the glycoside. The presence of the alkyl carbon chain leads to the hydrophobic tail to the molecule. When carbohydrate molecules react with fatty alcohol compounds, alkyl polyglycoside molecules are formed having single or multiple anhydroglucose units, which are termed monoglycosides and polyglycosides, respectively. The final alkyl polyglycoside product typically has a distribution of varying concentration of glucose units (or degree of polymerization).

The APGs that may be used in the detergent composition of the invention preferably comprise saccharide or polysaccharide groups (i.e., mono-, di-, tri-, etc. saccharides) of hexose or pentose, and a fatty aliphatic group having 6 to 20 carbon atoms. Preferred alkyl polyglycosides that can be used according to the present invention are represented by the general formula, Gx-O—R1, wherein G is a moiety derived from reducing saccharide containing 5 or 6 carbon atoms, e.g., pentose or hexose; R1 is fatty alkyl group containing 6 to 20 carbon atoms; and x is the degree of polymerization of the polyglycoside, representing the number of monosaccharide repeating units in the polyglycoside. Generally, x is an integer on the basis of individual molecules, but because there are statistical variations in the manufacturing process for APGs, x may be a noninteger on an average basis when referred to APG used as an ingredient for the detergent composition of the present invention. For the APGs of use in the compositions of the present invention, x preferably has a value of less than 2.5, and more preferably is between 1 and 2. Exemplary saccharides from which G can be derived are glucose, fructose, mannose, galactose, talose, gulose, allose, altrose, idose, arabinose, xylose, lyxose and ribose. Because of the ready availability of glucose, glucose is preferred in polyglycosides. The fatty alkyl group is preferably saturated, although unsaturated fatty chains may be used. Generally, the commercially available polyglycosides have C8 to C16 alkyl chains and an average degree of polymerization of from 1.4 to 1.6.

Commercially available alkyl polyglycoside can be obtained as concentrated aqueous solutions ranging from 50 to 70 wt % actives and are available from Cognis. Most preferred for use in the present compositions are APGs with an average degree of polymerization of from 1.4 to 1.7 and the chain lengths of the aliphatic groups are between C8 and C 16. For example, one preferred APG for use herein has chain length of C8 and C10 (ratio of 45:55) and a degree of polymerization of 1.7. The detergent compositions of the present invention have the advantage of having less adverse impact on the environment than conventional detergent compositions. Alkyl polyglycosides used in the present invention exhibit low oral and dermal toxicity and irritation on mammalian tissues. These alkyl polyglycosides are also biodegradable in both anaerobic and aerobic conditions and they exhibit low toxicity to plants, thus improving the environmental compatibility of the rinse aid of the present invention. Because of the carbohydrate property and the excellent water solubility characteristics, alkyl polyglycosides are compatible in high caustic and builder formulations. The detergent compositions may include a sufficient amount of alkyl polyglycoside surfactant in an amount that provides a desired level of cleaning on fabrics, that being from about 0.01% and about 10% by weight alkyl polyglycoside surfactant. Most preferred is to include an amount between about 0.5% and about 5% by weight actives.

The Natural Essences Component

In addition to anionic and nonionic surfactant components, the laundry detergents compositions of the present invention may include a “natural essence”. As referred to for purposes of this invention, “natural essence” is intended to include a broader class of natural products comprising natural oils extracted from plants and trees and their fruits, nuts and seeds, (for example by steam or liquid extraction of ground-up plant/tree material), natural products that may be purified by distillation, (i.e., purified single organic molecules or close boiling point “cuts” of organic materials such as terpenes and the like), and synthetic organic materials that are the synthetic versions of naturally occurring materials (e.g., either identical to the natural material, or the optical isomer, or the racemic mixture). An example of the latter is D,L-limonene that is synthetically prepared and is a good and eco-friendly substitute for natural orange oil (mostly D-limonene) when crop yields are expensive due to citrus crop freezes. Thus, it should be understood that “natural essence” incorporates a wide range of pure organic materials either natural or synthetic versions thereof, mixtures of these previously purified individual materials or distillate cuts of materials, and complex natural mixtures directly extracted from plant/tree materials through infusion, steam extraction, etc. Also, it should be understood that these natural essence ingredients may double as fragrance materials for the detergent composition, and in fact many natural extracts, oils, essences, infusions and such are very fragrant materials. However, for use in the present compositions, these materials are used at higher levels than would be typical for fragrance purposes, and it should be also understood that depending on optical isomers used, there may be no smell or a reduced smell, or even a masking effect to the human sensory perception. Thus by judicious choice of natural essence mixtures, performance boosting may be effected without making the compositions overwhelmingly scented. Also, actual fragrance masking materials (such as used for household cleaners and available from the fragrance supply houses such as International Flavors & Fragrances, Symrise, Givaudan, Firmenich, and others) may be added to mask the smells of the natural essences.

Some of the naturally derived essences for use in the present compositions include, but are not limited to, musk, civet, ambergis, castoreum and similar animal derived oils; abies oil, ajowan oil, almond oil, ambrette seed absolute, angelic root oil, anise oil, basil oil, bay oil, benzoin resinoid, bergamot oil, birch oil, bois de rose oil, broom abs., cajeput oil, cananga oil, capsicum oil, caraway oil, cardamon oil, carrot seed oil, cassia oil, cedar leaf oil, cedar wood oil, celery seed oil, cinnamon bark oil, citronella oil, clary sage oil, clove oil, cognac oil, coriander oil, cubeb oil, cumin oil, camphor oil, dill oil, elemi gum, estragon oil, eucalyptol nat., eucalyptus oil, fennel sweet oil, galbanum res., garlic oil, geranium oil, ginger oil, grapefruit oil, hop oil, hyacinth abs., jasmin abs., juniper berry oil, labdanum res., lavender oil, laurel leaf oil, lavender oil, lemon oil, lemongrass oil, lime oil, lovage oil, mace oil, mandarin oil, mimosa abs., myrrh abs., mustard oil, narcissus abs., neroli bigarade oil, nutmeg oil, oakmoss abs., olibanum res., onion oil, opoponax res., orange oil, orange flower oil, origanum, orris concrete, pepper oil, peppermint oil, peru balsam, petitgrain oil, pine needle oil, rose abs., rose oil, rosemary oil, safe officinalis oil, sandalwood oil, sage oil, spearmint oil, styrax oil, thyme oil, tolu balsam, tonka beans abs., tuberose abs., turpentine oil, vanilla beans abs., vetiver oil, violet leaf abs., ylang ylang oil and similar vegetable oils, etc.

Synthetic essences include but are not limited to pinene, limonene and like hydrocarbons; 3,3,5-trimethylcyclohexanol, linalool, geraniol, nerol, citronellol, menthol, borneol, borneyl methoxy cyclohexanol, benzyl alcohol, anise alcohol, cinnamyl alcohol, .beta.-phenyl ethyl alcohol, cis-3-hexenol, terpineol and like alcohols; anethole, musk xylol, isoeugenol, methyl eugenol and like phenols; .alpha.-amylcinnamic aldehyde, anisaldehyde, n-butyl aldehyde, cumin aldehyde, cyclamen aldehyde, decanal, isobutyl aldehyde, hexyl aldehyde, heptyl aldehyde, n-nonyl aldehyde, nonadienol, citral, citronellal, hydroxycitronellal, benzaldehyde, methyl nonyl acetaldehyde, cinnamic aldehyde, dodecanol, .alpha.-hyxylcinnamic aldehyde, undecenal, heliotropin, vanillin, ethyl vanillin and like aldehydes; methyl amyl ketone, methyl .beta.-naphthyl ketone, methyl nonyl ketone, musk ketone, diacetyl, acetyl propionyl, acetyl butyryl, carvone, menthone, camphor, acetophenone, p-methyl acetophenone, ionone, methyl ionone and like ketones; amyl butyrolactone, diphenyl oxide, methyl phenyl glycidate, gamma.-nonyl lactone, coumarin, cineole, ethyl methyl phenyl glicydate and like lactones or oxides; methyl formate, isopropyl formate, linalyl formate, ethyl acetate, octyl acetate, methyl acetate, benzyl acetate, cinnamyl acetate, butyl propionate, isoamyl acetate, isopropyl isobutyrate, geranyl isovalerate, allyl capronate, butyl heptylate, octyl caprylate octyl, methyl heptynecarboxylate, methine octynecarboxylate, isoacyl caprylate, methyl laurate, ethyl myristate, methyl myristate, ethyl benzoate, benzyl benzoate, methylcarbinylphenyl acetate, isobutyl phenylacetate, methyl cinnamate, cinnamyl cinnamate, methyl salicylate, ethyl anisate, methyl anthranilate, ethyl pyruvate, ethyl .alpha.-butyl butylate, benzyl propionate, butyl acetate, butyl butyrate, p-tert-butylcyclohexyl acetate, cedryl acetate, citronellyl acetate, citronellyl formate, p-cresyl acetate, ethyl butyrate, ethyl caproate, ethyl cinnamate, ethyl phenylacetate, ethylene brassylate, geranyl acetate, geranyl formate, isoamyl salicylate, isoamyl isovalerate, isobornyl acetate, linalyl acetate, methyl anthranilate, methyl dihydrojasmonate, nopyl acetate, .beta.-phenylethyl acetate, trichloromethylphenyl carbinyl acetate, terpinyl acetate, vetiveryl acetate and the like.

Suitable essence mixtures may produce synergistic performance attributes for the detergent composition and may help to impart an overall fragrance perception as well to the composition including but not limited to, fruity, musk, floral, herbaceous (including mint), and woody, or perceptions that are in-between (fruity-floral for example). Typically these essence or essential oil mixtures may be compounded by mixing a variety of these active extract or synthetic materials along with various solvents to adjust cost, viscosity, flammability, ease of handling, etc. Since many natural extract ingredients are compounded into fragrances, the essential oils, infusions, distillates, etc. that are considered “natural essences” within this invention are also available from the fragrance companies such as International Flavors & Fragrances, Givaudan, Symrise, Firmenich, Robertet, and many others. The natural essences for use in the present invention are preferably incorporated at a level of from about 0.1 wt % to about 5 wt % as the 100 wt % neat substance or mixture of substances. It is important to note that these levels tend to be greater than those levels used for scenting a product with a perfume.

The Builder Component

The laundry detergent compositions of the present invention may also include at least one builder. Builders are well known in the laundry detergent art and include such species as hydroxides, carbonates, sesquicarbonates, bicarbonates, borates, citrates, silicates, zeolites, and such. Preferred builders for use in the present invention include but are not limited to sodium hydroxide (NaOH), potassium hydroxide (KOH), magnesium hydroxide (Mg(OH)2), sodium carbonate (Na2CO3), potassium carbonate (K2CO3), sodium bicarbonate (NaHCO3), potassium bicarbonate (KHCO3), sodium sesquicarbonate (Na2CO3.NaHCO3.2H2O), sodium silicate (Si02/Na20), sodium borate (Na2B4O7-(H2O)10 or “borax”), citric acid (C6H8O7), monosodium citrate (NaC6H7O7), disodium citrate (Na2C6H6O7), and trisodium citrate (Na3C6H5O7), and mixtures thereof. It should be understood that combinations of free acid materials (like citric acid) when combined with alkali such as sodium hydroxide can generate the mono-, di-, or trisodium salts of citric acid in situ. The preferred level of builder for use in these laundry detergents is from about 0.1 wt % to about 5 wt % by weight.

Preferably, the composition comprises from 0 wt % to 5 wt % zeolite builder. The composition preferably comprises from 0 wt % to 3 wt %, or from 0 wt % to 2 wt %, or from 0 wt % to 1 wt % zeolite builder. It may even be preferred for the composition to be essentially free from zeolite builder. By essentially free from zeolite builder it is typically meant that the composition comprises no deliberately added zeolite builder. This is especially preferred if it is desirable for the composition to be very highly soluble, to minimise the amount of water-insoluble residues (for example, which may deposit on fabric surfaces), and also when it is highly desirable to have transparent wash liquor. Zeolite builders include zeolite A, zeolite X, zeolite P and zeolite MAP.

Preferably, the composition comprises from 0 wt % to 4 wt % phosphate builder. The composition preferably comprises from 0 wt % to 3 wt %, or from 0 wt % to 2 wt %, or from 0 wt % to 1 wt % phosphate builder. . It may even be preferred for the composition to be essentially free from phosphate builder. By essentially free from phosphate builder it is typically meant that the composition comprises no deliberately added phosphate builder. This is especially preferred if it is desirable for the composition to have a very good environmental profile. Phosphate builders include sodium tripolyphosphate.Preferably, the composition comprises from

Polymer Components

The compositions of the present invention may also include at least one soil dispersing and/or anti-redeposition or water conditioning polymers such as sodium polyacrylate or carboxymethylcellulose (CMC). Particularly suitable polymeric polycarboxylates are derived from acrylic acid, and this polymer and the corresponding neutralized forms include and are commonly referred to as polyacrylic acid, 2-propenoic acid homopolymer or acrylic acid polymer, and sodium polyacrylate, 2-propenoic acid homopolymer sodium salt, acrylic acid polymer sodium salt, poly sodium acrylate, or polyacrylic acid sodium salt. Preferred in the compositions of the present invention is sodium polyacrylate with average molecular weight from about 2,000 to 10,000, more preferably from about 4,000 to 7,000 and most preferably from about 4,000 to 5,000. Soluble polymers of this type are known materials, for example the sodium polyacrylates and polyacrylic acids from Rohm and Haas marketed under the trade name Acusol®. Of particular use in the present invention is the average 4500 molecular weight sodium polyacrylate, (for example, Acusol® 425, Acusol® 430, Acusol® 445 and Acusol® 445ND, and mixtures of these), and carboxymethylcellulose, either or a combination of the two at a preferred level of from about 0.1 wt % to about 3 wt %. Polyacrylates are “biodegradable”, however, the cellulosic materials such as CMC may show a faster biodegradation profile and may be more preferred in keeping with the spirit of the eco-friendly character of the present invention.

Electrolytes

The detergent compositions of the present invention may also include one or more electrolytes. For example, preferred electrolytes include but are not limited to sodium chloride, sodium sulfate, calcium chloride, and borax (sodium tetraborate-decahydrate), and combinations thereof. Of course, some of these have dual purposes such as alkalinity builders or enzyme stabilizers.

Enzyme Component

The compositions of the present invention may optionally include one or more detersive enzymes, either singly or in any combination of two or more. Enzymes may be included in the present detergent compositions for a variety of purposes, including removal of protein-based, carbohydrate-based, or triglyceride-based stains from substrates. Generally, suitable enzymes include cellulases, hemicellulases, proteases, gluco-amylases, amylases, lipases, cutinases, pectinases, xylanases, keratinases, reductases, oxidases, phenoloxidases, lipoxygenases, ligninases, pullulanases, tannases, chondriotinases, thermitases, pentosanases, malanases, .beta.-glucanases, arabinosidases or mixtures thereof of any suitable origin, such as vegetable, animal, bacterial, fungal and yeast origin. Preferred enzymes for use in the present invention are dictated by factors such as formula pH, thermostability, and stability to surfactants, builders and the like. In this respect bacterial or fungal enzymes are preferred, such as bacterial amylases and proteases, and fungal cellulases. A preferred combination is a detergent composition having a mixture of conventional detergent enzymes like protease, amylase, lipase, cutinase and/or cellulase. Suitable enzymes are also described in U.S. Pat. Nos. 5,677,272, 5,679,630, 5,703,027, 5,703,034, 5,705,464, 5,707,950, 5,707,951, 5,710,115, 5,710,116, 5,710,118, 5,710,119 and 5,721,202.

“Detersive enzyme”, as used herein, means any enzyme having a cleaning, stain removing or otherwise beneficial effect in a detergent compositions. Preferred detersive enzymes are hydrolases such as proteases, amylases and lipases. Highly preferred are amylases and/or proteases, including both current commercially available types and improved types. Enzymes are normally incorporated into detergent compositions at levels sufficient to provide a “cleaning-effective amount”. The term “cleaning effective amount” refers to any amount capable of producing a cleaning, stain removal, soil removal, whitening, deodorizing, or freshness improving effect on substrates such as fabrics, dishware and the like. In practical terms for current commercial preparations, typical amounts are up to about 5 mg by weight, more typically 0.01 mg to 3 mg, of active enzyme per gram of the detergent composition. In other words, the compositions herein will typically comprise from 0.001% to 5%, preferably 0.001%-1% by weight of a commercial enzyme preparation. Protease enzymes are usually present in such commercial preparations at levels sufficient to provide from 0.005 to 0.1 Anson units (AU) of activity per gram of composition. For certain detergents it may be desirable to increase the active enzyme content of the commercial preparation in order to minimize the total amount of non-catalytically active materials and thereby improve spotting/filming or other end-results. Higher active levels may also be desirable in highly concentrated detergent formulations. Proteolytic enzymes can be of animal, vegetable or microorganism (preferred) origin. The proteases for use in the detergent compositions herein include (but are not limited to) trypsin, subtilisin, chymotrypsin and elastase-type proteases. Preferred for use herein are subtilisin-type proteolytic enzymes. Particularly preferred is bacterial serine proteolytic enzyme obtained from Bacillus subtilis and/or Bacillus licheniformis. Suitable proteolytic enzymes include Novo Industri A/S Alcalase® (preferred), Esperase®, Savinase® (Copenhagen, Denmark), Gist-brocades' Maxatase®, Maxacal® and Maxapem 15®. (protein engineered Maxacal®) (Delft, Netherlands), and subtilisin BPN and BPN′ (preferred), which are commercially available. Preferred proteolytic enzymes are also modified bacterial serine proteases, such as those made by Genencor International, Inc. (San Francisco, Calif.), which are described in U.S. Pat. Nos. 5,972,682, 5,763,257 and 6,465,235 and which are also called herein “Protease B”. U.S. Pat. No. 5,030,378, Venegas, issued Jul. 9, 1991, refers to a modified bacterial serine proteolytic enzyme (Genencor International), which is called “Protease A” herein (same as BPN′). In particular, see columns 2 and 3 of U.S. Pat. No. 5,030,378 for a complete description, (including the amino sequence), of Protease A and its variants. Other proteases are sold under the tradenames: Primase®, Durazym®, Opticlean® and Optimase®. Preferred proteolytic enzymes, then, are selected from the group consisting of Alcalase® (Novo Industri A/S), BPN′, Protease A and Protease B (Genencor), and mixtures thereof. Protease B is most preferred. The compositions of the present invention will preferably contain at least about 0.0001%, more preferably at least about 0.0005%, and most preferably at least about 0.001% by weight of the composition of enzyme. The detergent composition will also preferably contain no more than about 5%, more preferably no more than about 2%, and most preferably, no more than about 1% by weight of the composition of enzyme. Although proteases may be used alone, it is preferable to have a combination of protease and amylase, or a combination of protease, lipase and amylase in the compositions of the present invention.

Enzyme Stabilization System

Preferably, the enzyme stabilization system selected from the group consisting of: formate salt selected from calcium formate and/or sodium formate; polyol selected from propane 1,2 diol, glycerol and/or sorbitol; and any combination thereof. Preferred are calcium formate and/or propane 1,2 diol.

Preferably, the composition comprises from 0.01 wt % to 0.5 wt % calcium cation, preferably from 0.03 wt % to 0.5 wt % calcium cation.

Preferably, the composition comprises from 0.1 wt % to 5 wt % formate anion, preferably from 0.3 wt % to 2 wt % formate anion.

Preferably, the composition comprises propane 1,2 diol, preferably from 0.5 wt % to 20 wt %, or from 1 wt % to 3 wt % propane 1,2 diol.

Preferably, the composition comprises calcium formate.

This preferred enzyme stabilization system enables good enzyme stability, and allows good surfactant stability. In a further preferred embodiment, these preferred enzyme stabilization systems also enable the removal of boron from the compositions.

Adjuvant

Optional ingredients for use in the present detergent compositions may also include peroxide and active oxygen (“peroxygen”) organic and inorganic compounds for non-chlorine bleaching of bleachable stains. Such bleaching materials may include, but are not limited to hydrogen peroxide, sodium percarbonate and sodium perborate, or mixtures thereof.

Additional optional materials for use in the present detergents may include chelants such as tetrasodium ethylenediamine tetraacetate-EDTA, Trilon® chelants from BASF, phosphates, zeolite, nitrilotriacetate (NTA) and it's corresponding salts, optical brighteners, dye fixatives or transfer inhibitors, perfumes, additional fragrance and fragrance masking agents to coordinate with the natural essences, odor neutralizers, dyes, pigments and colorants, solvents, cationic surfactants, other softening or antistatic agents, thickeners, emulsifiers, bleach catalysts, enzyme stabilizers, clays, surface modifying polymers, pH-buffering agents, abrasives, preservatives and sanitizers or disinfectants, anti-redeposition agents, opacifiers, anti-foaming agents, cyclodextrin, rheology-control agents, vitamins and other skin benefit agents, nano-particles and encapsulated particles, visible plastic particles, visible beads, etc., and the like, and any combination of adjuvant.

### EXAMPLES

| Example Number | 1 | 2 |
|---|---|---|
| Ingredient Weight Percentage | % | % |
| Lauryl ether sulphate | 12 | 11 |
| Palm AE3 sulphate | 9 | 8.5 |
| Palm alkyl 7-ethoxylate | 8 | 7.5 |
| Natural essences | 2 | 2 |
| Palm Fatty acid | 10 | 9.5 |
| Citric acid | 3 | 3 |
| Coupling polymer: Ethoxysulfated Hexamethylene | 2.2 | 2.2 |
| Diamine Dimethyl Quat * | | |
| Non-coupling cleaning polymer: PEG-PVAc | 0.9 | 0.8 |
| Polymer³ | | |
| Chelant: Hydroxyethane diphosphonic acid | 0 | 1.6 |
| Fluorescent Whitening Agent 49 | 0.2 | 0.2 |
| Non-aminofunctional solvent: 1,2 Propanediol | 8.5 | 6.0 |
| Non-aminofunctional solvent: Diethylene Glycol | — | 4.0 |
| Calcium formate | 0.1 | 0.1 |
| Calcium chloride | 0.06 | 0.06 |
| Potassium bisulfite | 0.3 | — |
| Perfume | 1.7 | 1.7 |
| Protease enzyme FNA (40.6 mg/g) | 1.5 | 1.5 |
| Amylase enzyme Termamyl Ultra (25.1 mg/g) | 0.1 | 0.1 |
| Mannanase enzyme (25 mg/g) | 0.1 | 0.1 |
| Cellulase enzyme (25 mg/g) | 0.1 | 0.1 |
| Xyloglucanase enzyme (20 mg/g) | 0.1 | 0.1 |
| Pectate lyase enzyme (20 mg/g) | 0.1 | 0.1 |
| Water & minors, e.g. antifoam, dyes | To | To |
| | 100 wt % | 100 wt % |

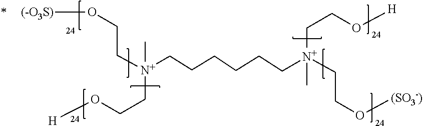

³PEG-PVA graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.

A solid laundry detergent composition is provided comprising: 5 wt % palm AE₁₋₃S; 15 wt % lauryl ether sulphate; 3 wt % palm AE5 alcohol; 15 wt % sodium carbonate; 2 wt % natural essences; 1 wt % enzymes (protease, amylase, cellulase, lipase); balance filler, misc and moisture.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry detergent composition comprising:
(a) from about 1 wt % to about 20 wt % by weight of an alkyl ether sulfate of the general formula:
R—(OCH₂CH₂)ₓ—O—SO₃M
wherein R is a non-petroleum derived fatty alcohol with even number of carbon chain lengths of from about C₈ to about C₂₀ and wherein x is from about 0.5 to about 8, and where M is an alkali metal or ammonium cation;
(b) optionally, from about 1 wt % to about 10 wt % by weight of a fatty alcohol ethoxylate of general formula:
R—(OCH2CH2-OH
wherein R is a non-petroleum derived fatty alcohol with even number carbon chain lengths of from about C₁₀ to about C₁₈, and wherein x is from about 0.5 to about 9; and
(c) optionally from about 0.1% to about 5% of a natural essence.

2. The laundry detergent composition of claim 1, wherein said laundry detergent composition is a solid laundry detergent composition, wherein said laundry detergent composition is substantially free of zeolite builder; wherein said laundry detergent composition is substantially free of phosphate builder; and wherein said laundry detergent composition is substantially free of silicate salt.

3. The laundry detergent composition of claim 2, further comprising an alpha-sulfonated fatty acid ester of general formula:
R₃—CH(SO₃M)-CO₂R₄
wherein R₃ is a non-petroleum derived C₈-C₂₀ carbon chain, R₄ is a straight chain C₁-C₂ alkyl group, and M is a cation selected from the group consisting of sodium, potassium, magnesium, and ammonium cations, and mixtures thereof.

4. The laundry detergent composition of claim 2, further comprising a detersive enzyme selected from the group consisting of lipase, cellulase, protease and amylase, and mixtures thereof.

5. The laundry detergent composition of claim 2, further comprising a fatty acid soap selected from the group consisting of sodium salts of saturated C₁₂-C₁₈ carboxylic acids, sodium salts of unsaturated C₁₂-C₁₈ carboxylic acids, potassium salts of saturated C₁₂-C₁₈ carboxylic acids, potassium salts of unsaturated C₁₄-C₁₈ carboxylic acids, and mixtures thereof.

6. The laundry detergent composition of claim 2, wherein said natural essence is a naturally occurring plant, tree, nut, seed, or fruit extract, or mixtures thereof.

7. The laundry detergent composition of claim 2, wherein said natural essence is a synthetic mixture of organic materials.

8. The laundry detergent composition of claim 1, further comprising a polymer selected from the group consisting of sodium polyacrylate having molecular weight from about 2,000 to about 10,000, and carboxy methyl cellulose, or mixtures thereof.

9. The laundry detergent composition of claim 1, wherein said natural essence is selected from the group consisting of musk oil, civet oil, ambergris oil, castoreum oil, abies oil, ajowan oil, almond oil, ambrette seed absolute, angelic root oil, anise oil, basil oil, bay oil, benzoin resinoid, bergamot oil, birch oil, bois de rose oil, broom absolute, cajeput oil, cananga oil, capsicum oil, caraway oil, cardamon oil, carrot seed oil, cassia oil, cedar leaf oil, cedar wood oil, celery seed oil, cinnamon bark oil, citronella oil, clary sage oil, clove oil, cognac oil, coriander oil, cubeb oil, cumin oil, camphor oil, dill oil, elemi gum, estragon oil, eucalyptol nat., eucalyptus oil, fennel sweet oil, galbanum res., garlic oil, geranium oil, ginger oil, grapefruit oil, hop oil, hyacinth absolute, jasmine absolute, juniper berry oil, labdanum res., lavender oil, laurel leaf oil, lemon oil, lemongrass oil, lime oil, lovage oil, mace oil, mandarin oil, mimosa absolute, myrrh absolute, mustard oil, narcissus absolute, neroli bigarade oil, nutmeg oil, oakmoss absolute, olibanum res., onion oil, opoponax res., orange oil, orange flower oil, origanum, orris concrete, pepper oil, peppermint oil, peru balsam, petitgrain oil, pine needle oil, rose absolute, rose oil, rosemary oil, safe officinalis oil, sandalwood oil, sage oil, spearmint oil, styrax oil, thyme oil, tolu balsam, tonka beans absolute, tuberose absolute, turpentine oil, vanilla beans absolute, vetiver oil, violet leaf absolute, ylang ylang oil, .alpha.-pinene, .beta.-pinene, d-limonene, 3,3,5-trimethylcyclohexanol, linalool, geraniol, nerol, citronellol, menthol, borneol, borneyl methoxy cyclohexanol, benzyl alcohol, anise alcohol, cinnamyl alcohol, .beta.-phenyl ethyl alcohol, cis-3-hexenol, terpineol, anethole, musk xylol, isoeugenol, methyl eugenol, .alpha.-amylcinnamic aldehyde, anisaldehyde, n-butylaldehyde, cumin aldehyde, cyclamen aldehyde, decanal, isobutyl aldehyde, hexyl aldehyde, heptyl aldehyde, n-nonyl aldehyde, nonadienol, citral, citronellal, hydroxycitronellal, benzaldehyde, methyl nonyl acetaldehyde, cinnamic aldehyde, dodecanol, .alpha.-hydroxylcinnamic aldehyde, undecenal, heliotropin, vanillin, ethyl vanillin, methyl amyl ketone, methyl .beta.-naphthyl ketone, methyl nonyl ketone, musk ketone, diacetyl, acetyl propionyl, acetyl butyryl, carvone, menthone, camphor, acetophenone, p-methyl acetophenone, ionone, methyl ionone, amyl butyrolactone, diphenyl oxide, methyl phenyl glycidate, .gamma.-nonyl lactone, coumarin, cineole, ethyl methyl phenyl glicydate, methyl formate, isopropyl formate, linalyl formate, ethyl acetate, octyl acetate, methyl acetate, benzyl acetate, cinnamyl acetate, butyl propionate, isoamyl acetate, isopropyl isobutyrate, geranyl isovalerate, allyl capronate, butyl heptylate, octyl caprylate octyl, methyl heptynecarboxylate, methine octynecarboxylate, isoacyl caprylate, methyl laurate, ethyl myristate, methyl myristate, ethyl benzoate, benzyl benzoate, methylcarbinylphenyl acetate, isobutyl phenylacetate, methyl cinnamate, cinnamyl cinnamate, methyl salicylate, ethyl anisate, methyl anthranilate, ethyl pyruvate, ethyl .alpha.-butyl butylate, benzyl propionate, butyl acetate, butyl butyrate, p-tert-butylcyclohexyl acetate, cedryl acetate, citronellyl acetate, citronellyl formate, p-cresyl acetate, ethyl butyrate, ethyl caproate, ethyl cinnamate, ethyl phenylacetate, ethylene brassylate, geranyl acetate, geranyl formate, isoamyl salicylate, isoamyl isovalerate, isobornyl acetate, linalyl acetate, methyl anthranilate, methyl dihydrojasmonate, nopyl acetate, .beta.-phenylethyl acetate, trichloromethylphenyl carbinyl acetate, terpinyl acetate, and vetiveryl acetate, and mixtures thereof.

10. The laundry detergent composition of claim 1, wherein said laundry detergent composition is a liquid laundry detergent composition, wherein the laundry detergent composition further comprises:
(a) optionally an enzyme; and
(b) optionally an enzyme stabilization system selected from the group consisting of: formate salt selected from calcium formate and/or sodium formate; polyol selected from propane 1,2 diol, glycerol and/or sorbitol; and any combination thereof.

11. The laundry detergent composition of claim 10, further comprising an alpha-sulfonated fatty acid ester of general formula:
R₃—CH(SO₃M)-CO₂R₄
wherein R₃ is a non-petroleum derived C₈-C₂₀ carbon chain, R₄ is a straight chain C₁-C₂ alkyl group, and M is a cation selected from the group consisting of sodium, potassium, magnesium, and ammonium cations, and mixtures thereof.

12. The laundry detergent composition of claim 10, further comprising a detersive enzyme selected from the group consisting of lipase, cellulase, protease and amylase, and mixtures thereof.

13. The laundry detergent composition of claim 10, further comprising a fatty acid soap selected from the group consisting of sodium salts of saturated C₁₂-C₁₈ carboxylic acids, sodium salts of unsaturated C₁₂-C₁₈ carboxylic acids, potassium salts of saturated C₁₂-C₁₈ carboxylic acids, potassium salts of unsaturated C₁₄-C₁₈ carboxylic acids, and mixtures thereof.

14. The laundry detergent composition of claim 10, wherein said natural essence is a naturally occurring plant, tree, nut, seed, or fruit extract, or mixtures thereof.

15. The laundry detergent composition of claim 10, wherein said natural essence is a synthetic mixture of organic materials.

16. The laundry detergent composition according to claim 10, wherein the composition is essentially free from boron.

17. The laundry detergent composition according to claim 10, wherein the composition comprises from 0.01 wt % to 0.5 wt % calcium cation.

18. The laundry detergent composition according to claim 10, wherein the composition comprises from 0.1 wt % to 5 wt % formate anion.

19. The laundry detergent composition according to claim 10, wherein the composition comprises propane 1,2 diol.

20. The laundry detergent composition according to claim 10, wherein the composition comprises calcium formate.
